(19) United States
(12) Patent Application Publication
(10) Pub. No.: US 2014/0115464 A1
(43) Pub. Date: Apr. 24, 2014

(54) ENTERTAINMENT SYSTEM WITH ENTERTAINMENT MANAGER MECHANISM AND METHOD OF OPERATION THEREOF

(71) Applicant: SAMSUNG ELECTRONICS CO., LTD., Gyeonggi-Do (KR)

(72) Inventors: Nina F. Shih, Mountain View, CA (US); Tom Brinck, Palo Alto, CA (US)

(73) Assignee: SAMSUNG ELECTRONICS CO., LTD., Gyeonggi-Do (KR)

(21) Appl. No.: 13/658,484

(22) Filed: Oct. 23, 2012

(51) Int. Cl. G06F 3/01

(52) U.S. Cl. 715/716

(57) ABSTRACT

A method of operation of an entertainment system includes: identifying an entertainment input type for classifying an entertainment activity; detecting an entertainment break period based on the entertainment input type; determining a task priority for temporally overlapping a schedule task with the entertainment break period; calculating an adjusted entertainment schedule based on the task priority for engaging in the entertainment activity and the schedule task; and generating a task-suggestion based on the adjusted entertainment schedule for displaying on a device.

### TECHNICAL FIELD

The present invention relates generally to an entertainment system, and more particularly to a system for scheduling of entertainment activities.

### BACKGROUND ART

Modern consumer electronics, such as televisions, cellular phones, portable digital assistants, and combination devices, are providing increasing levels of functionality to support modern life, including entertainment. As users become more empowered with the growth of technology, new and old paradigms begin to take advantage of this new device space.

The ever increasing need for scheduling various activities in modern life requires users to have access to information at all times, at increasing data rates, in order to optimize how users spend their time. However, the availability of information and various methods of receiving the information can also interrupt, distract, or overwhelm the user, especially in the context of entertainment.

Thus, a need still remains for an entertainment system with scheduler that can manage various information with regards to user's entertainment activities. In view of the increasing consumer needs, it is increasingly critical that answers be found to these problems. In view of the ever-increasing commercial competitive pressures, along with growing consumer expectations and the diminishing opportunities for meaningful product differentiation in the marketplace, it is critical that answers be found for these problems. Additionally, the need to reduce costs, improve efficiencies and performance, and meet competitive pressures adds an even greater urgency to the critical necessity for finding answers to these problems.

Solutions to these problems have been long sought but prior developments have not taught or suggested any solutions and, thus, solutions to these problems have long eluded those skilled in the art.

### DISCLOSURE OF THE INVENTION

The present invention provides a method of operation of an entertainment system including: identifying an entertainment input type for classifying an entertainment activity; detecting an entertainment break period based on the entertainment input type; determining a task priority for temporally overlapping a schedule task with the entertainment break period; calculating an adjusted entertainment schedule based on the task priority for engaging in the entertainment activity and the schedule task; and generating a task-suggestion based on the adjusted entertainment schedule for displaying on a device.

The present invention provides an entertainment system, including: a type-identification module for identifying an entertainment input type for classifying an entertainment activity; a break detection module, coupled to the type-identification module, for detecting an entertainment break period based on the entertainment input type; a task detail module, coupled to the break detection module, for determining a task priority for temporally overlapping a schedule task with the entertainment break period; a schedule optimization module, coupled to the task detail module, for calculating an adjusted entertainment schedule based on the task priority for engaging in the entertainment activity and the schedule task; and a message generator module, coupled to the schedule optimization module, for generating a task-suggestion based on the adjusted entertainment schedule for displaying on a device.

Certain embodiments of the invention have other steps or elements in addition to or in place of those mentioned above. The steps or elements will become apparent to those skilled in the art from a reading of the following detailed description when taken with reference to the accompanying drawings.

### BRIEF DESCRIPTION OF THE DRAWINGS

FIG. 1 is an entertainment system with entertainment-break utilizer mechanism in an embodiment of the present invention.

FIG. 2 is an example of a display interface of the first device.

FIG. 3 is a further example of the display interface of the first device.

FIG. 4 is an exemplary block diagram of the entertainment system.

FIG. 5 is a control flow of the entertainment system.

FIG. 6 is a flow chart of a method of operation of an entertainment system in a further embodiment of the present invention.

### BEST MODE FOR CARRYING OUT THE INVENTION

The following embodiments are described in sufficient detail to enable those skilled in the art to make and use the invention. It is to be understood that other embodiments would be evident based on the present disclosure, and that system, process, or mechanical changes may be made without departing from the scope of the present invention.

In the following description, numerous specific details are given to provide a thorough understanding of the invention. However, it will be apparent that the invention may be practiced without these specific details. In order to avoid obscuring the present invention, some well-known circuits, system configurations, and process steps are not disclosed in detail.

The drawings showing embodiments of the system are semi-diagrammatic and not to scale and, particularly, some of the dimensions are for the clarity of presentation and are shown exaggerated in the drawing FIGs. Similarly, although the views in the drawings for ease of description generally show similar orientations, this depiction in the FIGs. is arbitrary for the most part. Generally, the invention can be operated in any orientation.

The term “module” referred to herein can include software, hardware, or a combination thereof in accordance with the context in which the term is used. For example, the software can be machine code, firmware, embedded code, and application software. Also for example, the hardware can be circuitry, processor, computer, integrated circuit, integrated circuit cores, a pressure sensor, an inertial sensor, a microelectromechanical system (MEMS), passive devices, or a combination thereof.

The term “processing” as used herein includes filtering signals, decoding symbols, assembling data structures, transferring data structures to peripheral storage devices, manipulating data structures, and reading data structures from external sources. Data structures are defined to be files, input data, system generated data, such as calculated data, and program data.

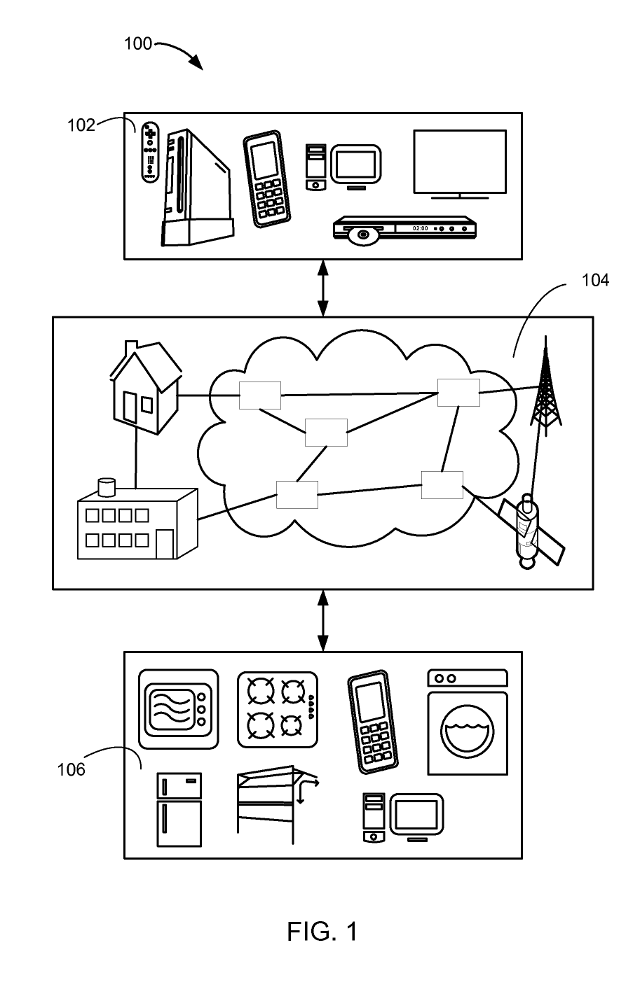

Referring now to FIG. 1, therein is shown an entertainment system 100 with entertainment-break utilizer mechanism in an embodiment of the present invention. The entertainment system 100 includes a first device 102 for engaging in entertainment activities, such as a personal computer, a laptop computer, a television, a smart phone, a game console, a media player, or a combination thereof.

For illustrative purposes, the entertainment system 100 is described with the first device 102 as a television, although it is understood that the first device 102 can be different types of computing devices. For example, the first device 102 can also be a mobile computing device, such as a smart phone or a laptop computer, or a non-mobile computing device, such as a server, a server farm, or a desktop computer.

The first device 102 can be connected to a communication path 104. The first device 102 can receive entertainment content, such as television or internet signals, through the communication path 104 for engaging in entertainment activities. The communication path 104 is defined as a system of wires, wired or wireless communications devices, or a combination thereof that are connected to each other for enabling communication between devices.

The communication path 104 can be a variety of networks. For example, the communication path 104 can include wireless communication, wired communication, optical, ultrasonic, or the combination thereof. Satellite communication, television broadcasting, cellular communication, Bluetooth, Infrared Data Association standard, wireless fidelity, and worldwide interoperability for microwave access are examples of wireless communication that can be included in the communication path 104. Ethernet, digital subscriber line, fiber to the home, and plain old telephone service are examples of wired communication that can be included in the communication path 104.

Further, the communication path 104 can traverse a number of network topologies and distances. For example, the communication path 104 can include direct connection, personal area network, local area network, metropolitan area network, wide area network or any combination thereof. Also for example, the communication path 104 can include a network within a building or an entity, such as a home network or a company network.

The entertainment system 100 can include a second device 106 for primarily engaging in non-entertainment related activities. The second device 106 can include devices having functions that can be used to engage in entertainment related activities. For example, the entertainment system 100 can display TV shows or track the progress of other game participants through an interface on the second device 106, such as a screen or a speaker.

The second device 106 can include appliances. For example, the second device 106 can include a microwave oven, a washer, a dryer, a stove, an oven, a refrigerator, a garage door system, a security system, or a combination thereof. The second device 106 can also include multifunctional devices operating in a non-entertainment context, such as a personal computer running a work-related program or a smart phone tracking a personal calendar. The second device 106 can also include a server or a communication hub, such as a router or a gateway.

The second device 106 can be connected to other devices, such as the first device 102, through the communication path 104. For example, the second device 106 can be a computer connected to the internet for telecommuting or a kitchen appliance directly communicating with the first device 102, such as a television or a smart phone.

The second device 106 can be tied to a specific location, such as a house or a commercial building. The second device 106 can also be a mobile device.

Also for illustrative purposes, the entertainment system 100 is shown with the second device 106 and the first device 102 as end points of the communication path 104, although it is understood that the entertainment system 100 can have a different partition between the first device 102, the second device 106, and the communication path 104. For example, the first device 102, the second device 106, or a combination thereof can also function as part of the communication path 104.

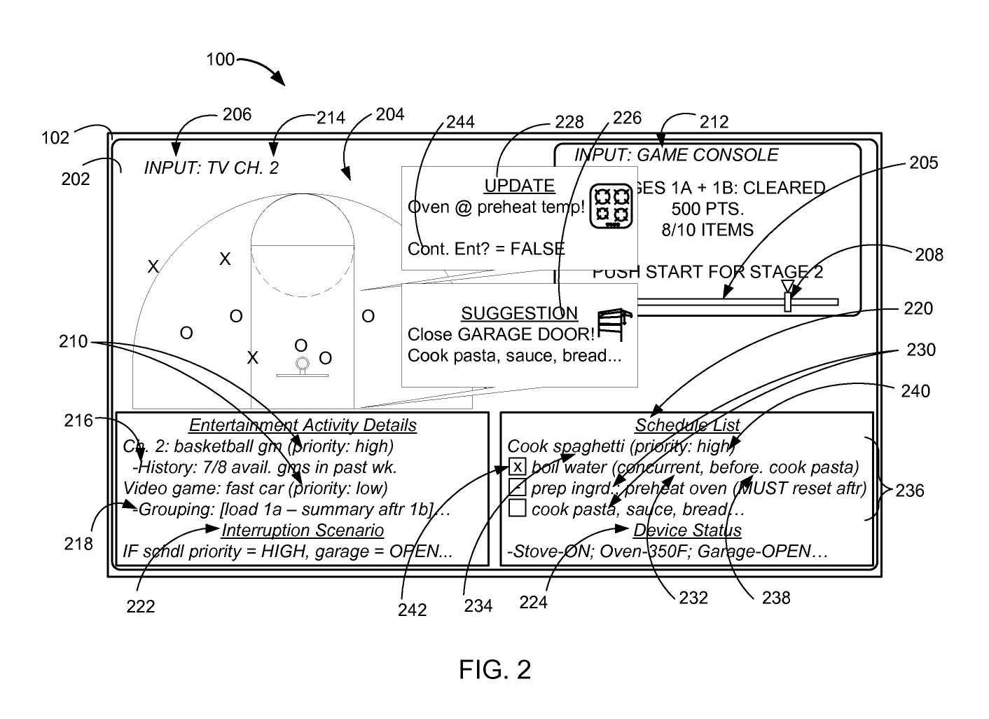

Referring now to FIG. 2, therein is shown an example of a display interface 202 of the first device 102. The display interface 202 can show an entertainment activity 204 having an entertainment input type 206, an entertainment break period 208, and an entertainment priority 210.

The entertainment activity 204 is defined as something a user (not shown) does for the user's enjoyment or personal motive. The entertainment activity 204 can be an activity facilitated by the first device 102. For example, the entertainment activity 204 can include watching a movie or a television show, playing a video game, listening to music, accessing a webpage, or a combination thereof using the first device 102. Also for example, the entertainment activity 204 can include watching a class lecture or instructions or tutorials on home repair.

The entertainment activity 204 can be subdivided into entertainment segments 205. The entertainment segments 205 are defined as groupings of portions within the entertainment activity 204. For example, the entertainment segments 205 can be acts or sequences of scenes in a movie or the content between commercial breaks in a television show. Also for example, the entertainment segments 205 can be levels or objectives within a video game.

The entertainment activity 204 can have the entertainment input type 206. The entertainment input type 206 is defined as a classification of a source for the entertainment activity 204. The entertainment input type 206 can be based on a characteristic of the source of the information utilized by the first device 102 for facilitating the entertainment activity 204.

The entertainment input type 206 can have a classification of a locally-controlled type 212. The locally-controlled type 212 is defined as a classification for indicating that the source of the information utilized by the first device 102 is directly controlled by the first device 102. The locally-controlled type 212 can indicate that the entertainment activity 204 is facilitated through information stored in the first device 102 or through information from a memory connected to the first device 102.

For example, the locally-controlled type 212 can indicate accessing a game, a show, or a movie stored within the first device 102. Also for example, the locally-controlled type 212 can indicate accessing a game, a movie, or a recording stored on an external memory device or a read-only memory connected to or loaded into the first device 102.

The entertainment input type 206 can also have a classification of an externally-controlled type 214. The externally-controlled type 214 is defined as a classification for indicating that control for the source of information utilized by the first device 102 is external from the first device 102 or shared with the first device 102. The source of the information can be controlled by another device or entity for the externally-controlled type 214.

For example, the externally-controlled type 214 can include receiving television or radio broadcast signal. Also for example, the externally-controlled type 214 can include accessing a multi-player game or communication over the internet or a local network.

The entertainment input type 206 can be distinguished by a level of control by the first device 102 for the entertainment activity 204. The entertainment input type 206 can be distinguished by the level of control over the schedule or the progress of the entertainment activity 204.

For example, the entertainment activity 204 can be the locally-controlled type 212 when commencement of the entertainment activity 204 is controlled by the first device 102. Also for example, the entertainment activity 204 can be the externally-controlled type 214 when the control for pausing and continuing is external to the first device 102.

The entertainment break period 208 is defined as a segment of time between groupings of portions within the entertainment activity 204. The entertainment break period 208 can be a period of time between the entertainment segments 205.

For example, the entertainment break period 208 can be the segment of time for a commercial break or a time spent during user initiated pause. Also for example, the entertainment break period 208 can be the period of time spent for loading content, for displaying set-up or summary content between levels, goals, or sessions in a game. For further example, the entertainment break period 208 can be the period time spent downloading the content and the period of time between pausing and resuming the entertainment activity 204 by the user.

The entertainment break period 208 can include a start time, stop time, markers relative to a current time, or a combination thereof. The entertainment break period 208 can be determined by the entertainment system 100.

The entertainment activity 204 can include the entertainment priority 210. The entertainment priority 210 is defined as an indication for representing the importance or preference of the entertainment activity 204 for the user. The entertainment priority 210 can be used to schedule the entertainment activity 204 relative to other activities for the user.

The entertainment priority 210 can be high, middle, or low based on user input or comparing measureable user activities to corresponding threshold levels. The entertainment priority 210 can also be represented by a count or a score. For example, the entertainment priority 210 can be represented by the number times the user engaged on the entertainment activity 204 within the last month, average number pauses for previous activities, an average duration of the activity, availability of the activity, user rating, or a combination thereof.

The entertainment priority 210 can be determined through a variety of ways, including using the entertainment priority 210, an entertainment history 216, or a combination thereof. Details regarding determination of the entertainment priority 210 and the use thereof will be discussed below.

The entertainment history 216 is defined as a record of previous occurrences of the entertainment activity 204. The entertainment history 216 can include previous availabilities of the entertainment activity 204 or related content, such as movies that are sequels or prequels of the entertainment activity 204. The entertainment history 216 can also include the entertainment priority 210, time and date, related context, or a combination thereof corresponding to the previous availabilities of the entertainment activity 204 or the related content.

The entertainment history 216 can also include behavior of the user corresponding to the previous availabilities of the entertainment activity 204 or the related content. For example, the entertainment history 216 can include frequency within a time period, amount or timing of pauses, concurrently engaged events, ignored events, or a combination thereof corresponding to the previous availabilities of the entertainment activity 204 or the related content.

Various instances of the entertainment break period 208 can be grouped to form a break-period grouping 218. The break-period grouping 218 can be grouped based on the entertainment input type 206, the entertainment priority 210, the entertainment history 216, or a combination thereof. For example, the break-period grouping 218 can be the television commercials played between segments of a television program or automatic data save portions within a video game for a given goal or level.

The display interface 202 can also show a schedule list 220, an interruption scenario 222, a device-status 224, a task-suggestion 226, and a schedule update 228. The schedule list 220 can be a list of tasks, reminders, chores, or a combination thereof for the user. The schedule list 220 can be a portion of the user's personal calendar.

The schedule list 220 can also be a list of suggested tasks based on the user's previous behavior, context, time, or a combination thereof. For example, the schedule list 220 can include tasks relevant to cooking dinner between 4:00 pm to 7:00 pm based on the user's behavior of having dinner between 6:00 pm to 8:00 pm. Also, for example, the schedule list 220 can have chilling drinks as a task contextually based on an upcoming party.

The schedule list 220 can have a schedule task 230, an entertainment-concurrent task 232, or a combination thereof. The schedule task 230 is defined as a representation of a non-entertainment related activity for the user. The schedule task 230 can be an individual instance of the tasks, reminders, or chores in the schedule list 220 listed as a title, a type or category, or a combination thereof.

The schedule task 230 can be based on the second device 106 of FIG. 1. For example, the schedule task 230 can be to fix the refrigerator or call the repair service based on a notification received from the user's refrigerator. Also, for example, the schedule task 230 can be to put the laundry in the dryer based on notifications from the washer, the dryer, or a combination thereof.

The schedule task 230 can be categorized as the entertainment-concurrent task 232. The entertainment-concurrent task 232 is defined as a non-entertainment related activity for the user that can occur concurrently with the entertainment activity 204. The entertainment-concurrent task 232 can be the schedule task 230 user can perform while engaging in the entertainment activity 204, such as watching television or playing video games. For example, the entertainment-concurrent task 232 can include folding or sorting laundry, exercising, food preparations, eating, cleaning, or a combination thereof.

It has been discovered that the entertainment-concurrent task 232 provides increased scheduling possibilities and more efficient scheduling results. The entertainment-concurrent task 232 provides the scheduling benefits by enabling and calculating for simultaneous activities.

The schedule task 230 can have a task context 234. The task context 234 is defined as a purpose or a theme for conducting the schedule task 230. For example, boiling the water can be for the purposes of cooking a specific dish or of making tea. Also for example, closing the garage door can be for the theme of arriving at home or securing the house.

It has been discovered that the task context 234 provide increased choices resulting in further optimization of the user's time. The task context 234 provide the scheduling benefit by categorizing various choices of the schedule task 230, which enables swapping instances of the schedule task 230 in the user's schedule for instances that better optimize the user's time while providing the same category of task. For example, the entertainment system 100 can suggest different dishes to cook or different ordering of doing the laundry, such as between light and dark colored loads based on the user's time and preference.

Various instances of the schedule task 230, the entertainment-concurrent task 232, or a combination thereof can be grouped to form a task grouping 236. The task grouping 236 can be a grouping of the schedule task 230, the entertainment-concurrent task 232, or a combination thereof based on an overarching theme or common purpose. The task grouping 236 can be grouped based on the task context 234.

For example, preheating the oven, preparing the ingredients, putting the ingredients in the oven, and removing the food from the oven after a specified time can have the task context 234 generally for cooking or specifically for cooking a specified dish or set of dishes. Also for example, sorting the laundry, operating the washer and dryer, and folding the laundry can have the task context 234 of generally for doing laundry or specifically for washing white clothes.

It has been discovered that the task grouping 236 and the break-period grouping 218 provide accurate and efficient arrangements of the user's activities. The task grouping 236 and the break-period grouping 218 provide the accuracy by analyzing relevant groups of events and maintaining the contextual and sequential relationship between the activities.

The schedule list 220 can also have a sequential connection 238 between instances of the schedule task 230, the entertainment-concurrent task 232, or a combination thereof in the task grouping 236. The sequential connection 238 is defined as a particular order for the contents of the schedule list 220. The sequential connection 238 can be based on the task context 234.

For example, the schedule list 220 can have an instance of the schedule task 230 for completing a wash cycle on the washing machine before an instance of the schedule task 230 for running the dryer for a specified amount of time, with the tasks having the task context 234 of doing the laundry. Also, for example, the schedule list 220 can have an instance of the schedule task 230 for preparing the ingredients before an instance of the schedule task 230 for kneading a dough, an instance of the entertainment-concurrent task 232 for boiling the ingredients to cook the soup, or a combination thereof, with the tasks having the task context 234 of cooking bread and soup.

The schedule task 230 can have a task priority 240 and a task-completion status 242. The task priority 240 is defined as an indication for representing the importance or preference of the schedule task 230 for the user. The task priority 240 can be used to schedule the schedule task 230 relative to other activities for the user.

The task priority 240 can be high, middle, or low based on user input or comparing measureable user activities to corresponding threshold levels. The task priority 240 can also be represented by a count or a score. For example, the task priority 240 can be represented by the number times the user engaged on the schedule task 230 within the last month, number times the user ignored reminders related to the schedule task 230, or a combination thereof.

The task priority 240 can be determined through a variety of ways, including using the task context 234. Details regarding determination of the task priority 240 and the use thereof will be discussed below.

It has been discovered that the entertainment priority 210 and the task priority 240 provide scheduling that best models the user's preferences and openness to distractions regarding entertainment and task related activities. The entertainment priority 210 and the task priority 240 provide the scheduling benefit by providing quantized and measurable input parameter enabling comparisons and measurements related to optimization methods.

The task-completion status 242 is defined as an indication for identifying the completion of the schedule task 230. The task-completion status 242 can be a value from a known set for representing a completion status of the schedule task 230.

For example, the task-completion status 242 can be a Boolean value, a zero or non-zero value, true or false indication, or a combination thereof. Also for example, the task-completion status 242 can be a percentage or number of task representing a progress for identifying the completion of the schedule task 230. Details regarding the identification and the use of the task-completion status 242 will be discussed below.

The task-completion status 242 can be based on the device-status 224. The device-status 224 is defined as an indication for identifying a status of the second device 106. For example, the device-status 224 can be an on-off status of the second device 106 or portions thereof, such as individual burners on the stove. Also, for example, the device-status 224 can include a temperature reading, a failure detection, a change in state, an input detection, a timer reading, or a combination thereof. Details regarding the identification and the use of the device-status 224 will be discussed below.

The interruption scenario 222 is defined as a situation for disturbing the entertainment activity 204. The interruption scenario 222 can be a set of conditions that needs to be satisfied before the entertainment system 100 pauses or stops the entertainment activity 204 or notifies the user during the entertainment activity 204. The interruption scenario 222 can be based on the device-status 224, the entertainment input type 206, the entertainment priority 210, the task context 234, the task priority 240, or a combination thereof.

For example, the interruption scenario 222 can be to always interrupt the entertainment activity 204 for the device-status 224 from a smoke detector or when the task priority 240 is greater than the entertainment priority 210. Also for example, the interruption scenario 222 can be to adjust the entertainment priority 210, the task priority 240, or both to decrease interruptions when the entertainment input type is the externally-controlled type 214.

The task-suggestion 226 is defined as a message to the user to recommend engaging in the schedule task 230. The task-suggestion 226 can be visually displayed, such as using a pop-up symbol or a scrolling message, or audibly communicated, such as through a pre-recorded message or a specified sound or a sequence of different sounds. The entertainment system 100 can communicate the task-suggestion 226 before, during, after, or a combination thereof relative to the entertainment break period 208.

The schedule update 228 is defined as a message to the user for informing the user of a status or progress of the schedule task 230. The schedule update 228 can be visually displayed, such as using a pop-up symbol or a scrolling message, or audibly communicated, such as through a pre-recorded message or a specified sound or a sequence of different sounds. The entertainment system 100 can communicate the schedule update 228 before, during, after, or a combination thereof relative to the entertainment break period 208.

The display interface 202 can further show a representation of an entertainment-continuation status 244. The entertainment-continuation status 244 is defined as an indication for continuing the entertainment activity 204.

The entertainment-continuation status 244 can be used as a requirement for continuing the entertainment activity 204 after the entertainment break period 208. For example, the entertainment-continuation status 244 can be required to continue the entertainment activity 204 based on the entertainment input type 206, the entertainment priority 210, the task context 234, the task priority 240, the task-completion status 242, the device-status 224, the interruption scenario 222, or a combination thereof.

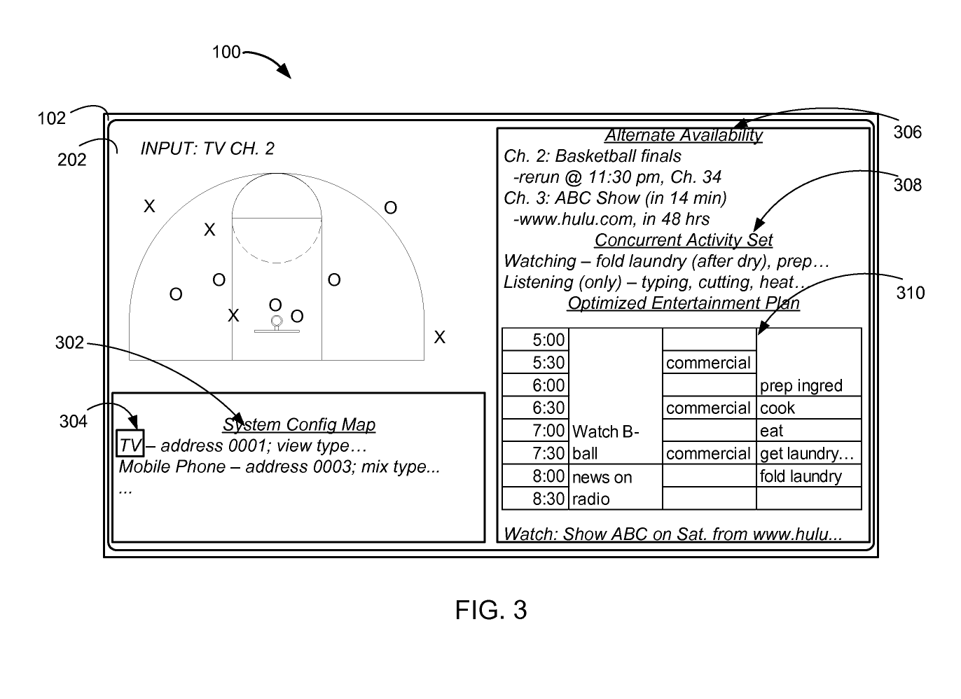

Referring now to FIG. 3, therein is shown a further example of the display interface 202 of the first device 102. The display interface 202 can show a system configuration map 302, a controlling device status 304, or a combination thereof.

The system configuration map 302 can be a grouping of information regarding the devices related to the entertainment system 100. The system configuration map 302 can include device identification, protocol for communication, device type, device location or address, or a combination thereof. The system configuration map 302 can be information of devices that are in the entertainment system 100, coupled to or controlled by the entertainment system 100, or a combination thereof.

The system configuration map 302 can include the controlling device status 304. The controlling device status 304 can be an indication for the device used for interfacing with the user. The controlling device status 304 can be set for the first device 102. The controlling device status 304 can be set for multiple devices. The controlling device status 304 can be set for the device determined as facilitating the entertainment activity 204 of FIG. 2. The determination for facilitating the entertainment activity 204 will be discussed in detail below.

The display interface 202 can also show a substitute availability 306, a concurrent activity set 308, and an adjusted entertainment schedule 310. The substitute availability 306 is defined as a different time, source, or a combination thereof for engaging in the entertainment activity 204.

The substitute availability 306 can have a different source, such as a different channel or website, different from the currently or immediately available instance of the entertainment activity 204. The substitute availability 306 can also have a different time, such as a schedule for rebroadcasting or when the content becomes accessible over the internet, different from the currently or immediately available instance of the entertainment activity 204.

It has been discovered that the substitute availability 306, the entertainment priority 210 of FIG. 2, and the task priority 240 of FIG. 2 provide increased scheduling possibilities for modeling the user's preferences. The substitute availability 306, the entertainment priority 210, and the task priority 240 provide the scheduling benefit by identifying various choices that the user will consider in balancing the task and entertainment activities.

The concurrent activity set 308 is defined as a grouping of various tasks or types of tasks identified as being able to concurrently occur with the entertainment activity 204. The concurrent activity set 308 can include tasks or types of tasks that can be performed while engaging in any or particular instances of the entertainment activity 204. For example, the concurrent activity set 308 can have folding laundry, certain food ingredient preparation steps, such as grinding or marinating, running a program on a different device, such as an analysis, simulation, or cleanup program, or a combination thereof.

It has been discovered that the entertainment-concurrent task 232 of FIG. 2 and the concurrent activity set 308 provide increased scheduling possibilities and more efficient scheduling results. The entertainment-concurrent task 232 and the concurrent activity set 308 provide the scheduling benefits by enabling and calculating for simultaneous activities.

The adjusted entertainment schedule 310 is defined as a sequential order of an entertainment related activity, a task related activity, or a combination thereof optimizing the user's time. The adjusted entertainment schedule 310 can be a schedule having the entertainment activity 204, the entertainment break period 208 of FIG. 2, the schedule task 230 of FIG. 2, the entertainment-concurrent task 232, the task grouping 236 of FIG. 2, or a combination thereof.

The adjusted entertainment schedule 310 can have the entries in the schedule arranged according to specific time, duration, ordering relative to other entries, overlapping other entries, or a combination thereof. The adjusted entertainment schedule 310 can be the arrangement that best optimizes the use of the user's time according to various considerations. The details regarding the optimization and calculation of the adjusted entertainment schedule 310 will be discussed below.

It has been discovered that the adjusted entertainment schedule 310 based on the entertainment input type 206 of FIG. 2, the entertainment priority 210, the substitute availability 306, the break-period grouping 218 of FIG. 2, the task context 234 of FIG. 2, the task priority 240, the entertainment-concurrent task 232, the task grouping 236, the concurrent activity set 308, the device-status 224 of FIG. 2, or a combination thereof provide accurate and more efficient use for the user's time. The adjusted entertainment schedule 310 provides the scheduling benefit by providing the result of optimizing the user's time using numerous considerations and scenarios.

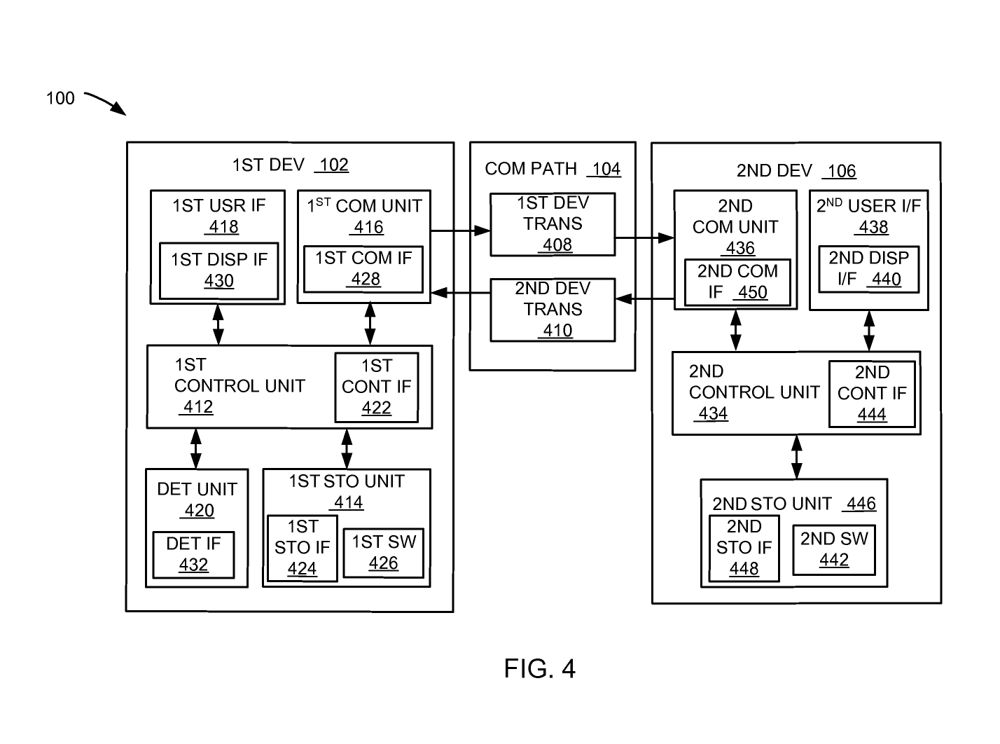

Referring now to FIG. 4, therein is shown an exemplary block diagram of the entertainment system 100. The entertainment system 100 can include the first device 102, the communication path 104, and the second device 106. The first device 102 can send information in a first device transmission 408 over the communication path 104 to the second device 106. The second device 106 can send information in a second device transmission 410 over the communication path 104 to the first device 102.

For brevity of description in this embodiment of the present invention, the first device 102 will be described as a television and the second device 106 will be described as a household appliance. The present invention is not limited to this selection for the type of devices. The selection is an example of the present invention.

The first device 102 can include a first control unit 412, a first storage unit 414, a first communication unit 416, a first user interface 418, and a detection unit 420. The first device 102 can be similarly described by the first device 102.

The first control unit 412 can include a first control interface 422. The first control unit 412 can execute a first software 426 to provide the intelligence of the entertainment system 100. The first control unit 412 can be implemented in a number of different manners. For example, the first control unit 412 can be a processor, an embedded processor, a microprocessor, a hardware control logic, a hardware finite state machine (FSM), a digital signal processor (DSP), or a combination thereof. The first control interface 422 can be used for communication between the first control unit 412 and other functional units in the first device 102. The first control interface 422 can also be used for communication that is external to the first device 102.

The first control interface 422 can receive information from the other functional units or from external sources, or can transmit information to the other functional units or to external destinations. The external sources and the external destinations refer to sources and destinations external to the first device 102.

The first control interface 422 can be implemented in different ways and can include different implementations depending on which functional units or external units are being interfaced with the first control interface 422. For example, the first control interface 422 can be implemented with a pressure sensor, an inertial sensor, a microelectromechanical system (MEMS), optical circuitry, waveguides, wireless circuitry, wireline circuitry, or a combination thereof.

The detection unit 420 can generate various information. For example, the detection unit 420 can generate current location of the first device 102. Also for example, the detection unit 420 can generate information regarding the environment surrounding the first device, including detecting a presence of a person or identifying the user.

The detection unit 420 can be implemented in many ways. For example, the detection unit 420 can function as at least a part of a global positioning system (GPS), an inertial or a cellular-tower location system, a camera, a fingerprint detector, an environmental sensor, or any combination thereof.

The detection unit 420 can include a detection interface 432. The detection interface 432 can be used for communication between the detection unit 420 and other functional units in the first device 102. The detection interface 432 can also be used for communication that is external to the first device 102.

The detection interface 432 can receive information from the other functional units or from external sources, or can transmit information to the other functional units or to external destinations. The external sources and the external destinations refer to sources and destinations external to the first device 102.

The detection interface 432 can include different implementations depending on which functional units or external units are being interfaced with the detection unit 420. The detection interface 432 can be implemented with technologies and techniques similar to the implementation of the first control interface 422.

The first storage unit 414 can store the first software 426. The first storage unit 414 can also store the relevant information, such as status transmission protocols or conditions, previous communications with other devices, user profile, previous usage record or pattern, or any combination thereof.

The first storage unit 414 can be a volatile memory, a nonvolatile memory, an internal memory, an external memory, or a combination thereof. For example, the first storage unit 414 can be a nonvolatile storage such as non-volatile random access memory (NVRAM), Flash memory, disk storage, or a volatile storage such as static random access memory (SRAM).

The first storage unit 414 can include a first storage interface 424. The first storage interface 424 can be used for communication between the detection unit 420 and other functional units in the first device 102. The first storage interface 424 can also be used for communication that is external to the first device 102.

The first storage interface 424 can receive information from the other functional units or from external sources, or can transmit information to the other functional units or to external destinations. The external sources and the external destinations refer to sources and destinations external to the first device 102.

The first storage interface 424 can include different implementations depending on which functional units or external units are being interfaced with the first storage unit 414. The first storage interface 424 can be implemented with technologies and techniques similar to the implementation of the first control interface 422.

The first communication unit 416 can enable external communication to and from the first device 102. For example, the first communication unit 416 can permit the first device 102 to communicate with the second device 106 of FIG. 1, an attachment, such as a peripheral device or a computer desktop, and the communication path 104.

The first communication unit 416 can also function as a communication hub allowing the first device 102 to function as part of the communication path 104 and not limited to be an end point or terminal unit to the communication path 104. The first communication unit 416 can include active and passive components, such as microelectronics or an antenna, for interaction with the communication path 104.

The first communication unit 416 can include a first communication interface 428. The first communication interface 428 can be used for communication between the first communication unit 416 and other functional units in the first device 102. The first communication interface 428 can receive information from the other functional units or can transmit information to the other functional units.

The first communication interface 428 can include different implementations depending on which functional units are being interfaced with the first communication unit 416. The first communication interface 428 can be implemented with technologies and techniques similar to the implementation of the first control interface 422.

The first user interface 418 allows a user (not shown) to interface and interact with the first device 102. The first user interface 418 can include an input device and an output device. Examples of the input device of the first user interface 418 can include a keypad, a touchpad, soft-keys, a keyboard, a microphone, or any combination thereof to provide data and communication inputs.

The first user interface 418 can include a first display interface 430. The first display interface 430 can include a display, a projector, a video screen, a speaker, or any combination thereof.

The first control unit 412 can operate the first user interface 418 to display information generated by the entertainment system 100. The first control unit 412 can also execute the first software 426 for the other functions of the entertainment system 100, including receiving location information from the detection unit 420. The first control unit 412 can further execute the first software 426 for interaction with the communication path 104 via the first communication unit 416.

The second device 106 can be optimized for implementing the present invention in a multiple device embodiment with the first device 102. The second device 106 can provide the additional or higher performance processing power compared to the first device 102. The second device 106 can include a second control unit 434, a second communication unit 436, and a second user interface 438.

The second user interface 438 allows a user (not shown) to interface and interact with the second device 106. The second user interface 438 can include an input device and an output device. Examples of the input device of the second user interface 438 can include a keypad, a touchpad, soft-keys, a keyboard, a microphone, or any combination thereof to provide data and communication inputs. Examples of the output device of the second user interface 438 can include a second display interface 440. The second display interface 440 can include a display, a projector, a video screen, a speaker, or any combination thereof.

The second control unit 434 can execute a second software 442 to provide the intelligence of the second device 106 of the entertainment system 100. The second software 442 can operate in conjunction with the first software 426. The second control unit 434 can provide additional performance compared to the first control unit 412.

The second control unit 434 can operate the second user interface 438 to display information. The second control unit 434 can also execute the second software 442 for the other functions of the entertainment system 100, including operating the second communication unit 436 to communicate with the first device 102 over the communication path 104.

The second control unit 434 can be implemented in a number of different manners. For example, the second control unit 434 can be a processor, an embedded processor, a microprocessor, a hardware control logic, a hardware finite state machine (FSM), a digital signal processor (DSP), or a combination thereof.

The second control unit 434 can include a second controller interface 444. The second controller interface 444 can be used for communication between the second control unit 434 and other functional units in the second device 106. The second controller interface 444 can also be used for communication that is external to the second device 106.

The second controller interface 444 can receive information from the other functional units or from external sources, or can transmit information to the other functional units or to external destinations. The external sources and the external destinations refer to sources and destinations external to the second device 106.

The second controller interface 444 can be implemented in different ways and can include different implementations depending on which functional units or external units are being interfaced with the second controller interface 444. For example, the second controller interface 444 can be implemented with a pressure sensor, an inertial sensor, a microelectromechanical system (MEMS), optical circuitry, waveguides, wireless circuitry, wireline circuitry, or a combination thereof.

A second storage unit 446 can store the second software 442. The second storage unit 446 can also store the relevant information, such as status transmission protocols or conditions, previous communications with other devices, user profile, previous usage record or pattern, or any combination thereof. The second storage unit 446 can be sized to provide the additional storage capacity to supplement the first storage unit 414.

For illustrative purposes, the second storage unit 446 is shown as a single element, although it is understood that the second storage unit 446 can be a distribution of storage elements. Also for illustrative purposes, the entertainment system 100 is shown with the second storage unit 446 as a single hierarchy storage system, although it is understood that the entertainment system 100 can have the second storage unit 446 in a different configuration. For example, the second storage unit 446 can be formed with different storage technologies forming a memory hierarchal system including different levels of caching, main memory, rotating media, or off-line storage.

The second storage unit 446 can be a volatile memory, a nonvolatile memory, an internal memory, an external memory, or a combination thereof. For example, the second storage unit 446 can be a nonvolatile storage such as non-volatile random access memory (NVRAM), Flash memory, disk storage, or a volatile storage such as static random access memory (SRAM).

The second storage unit 446 can include a second storage interface 448. The second storage interface 448 can be used for communication between the detection unit 420 and other functional units in the second device 106. The second storage interface 448 can also be used for communication that is external to the second device 106.

The second storage interface 448 can receive information from the other functional units or from external sources, or can transmit information to the other functional units or to external destinations. The external sources and the external destinations refer to sources and destinations external to the second device 106.

The second storage interface 448 can include different implementations depending on which functional units or external units are being interfaced with the second storage unit 446. The second storage interface 448 can be implemented with technologies and techniques similar to the implementation of the second controller interface 444.

The second communication unit 436 can enable external communication to and from the second device 106. For example, the second communication unit 436 can permit the second device 106 to communicate with the first device 102 over the communication path 104.

The second communication unit 436 can also function as a communication hub allowing the second device 106 to function as part of the communication path 104 and not limited to be an end point or terminal unit to the communication path 104. The second communication unit 436 can include active and passive components, such as microelectronics or an antenna, for interaction with the communication path 104.

The second communication unit 436 can include a second communication interface 450. The second communication interface 450 can be used for communication between the second communication unit 436 and other functional units in the second device 106. The second communication interface 450 can receive information from the other functional units or can transmit information to the other functional units.

The second communication interface 450 can include different implementations depending on which functional units are being interfaced with the second communication unit 436. The second communication interface 450 can be implemented with technologies and techniques similar to the implementation of the second controller interface 444.

The first communication unit 416 can couple with the communication path 104 to send information to the second device 106 in the first device transmission 408. The second device 106 can receive information in the second communication unit 436 from the first device transmission 408 of the communication path 104.

The second communication unit 436 can couple with the communication path 104 to send information to the first device 102 in the second device transmission 410. The first device 102 can receive information in the first communication unit 416 from the second device transmission 410 of the communication path 104. The entertainment system 100 can be executed by the first control unit 412, the second control unit 434, or a combination thereof.

For illustrative purposes, the second device 106 is shown with the partition having the second user interface 438, the second storage unit 446, the second control unit 434, and the second communication unit 436, although it is understood that the second device 106 can have a different partition. For example, the second software 442 can be partitioned differently such that some or all of its function can be in the second control unit 434 and the second communication unit 436. Also, the second device 106 can include other functional units not shown in FIG. 4 for clarity.

The functional units in the first device 102 can work individually and independently of the other functional units. The first device 102 can work individually and independently from the second device 106 and the communication path 104.

The functional units in the second device 106 can work individually and independently of the other functional units. The second device 106 can work individually and independently from the first device 102 and the communication path 104.

For illustrative purposes, the entertainment system 100 is described by operation of the first device 102 and the second device 106. It is understood that the first device 102 and the second device 106 can operate any of the modules and functions of the entertainment system 100. For example, the first device 102 is described to operate the detection unit 420, although it is understood that the second device 106 can also operate the detection unit 420.

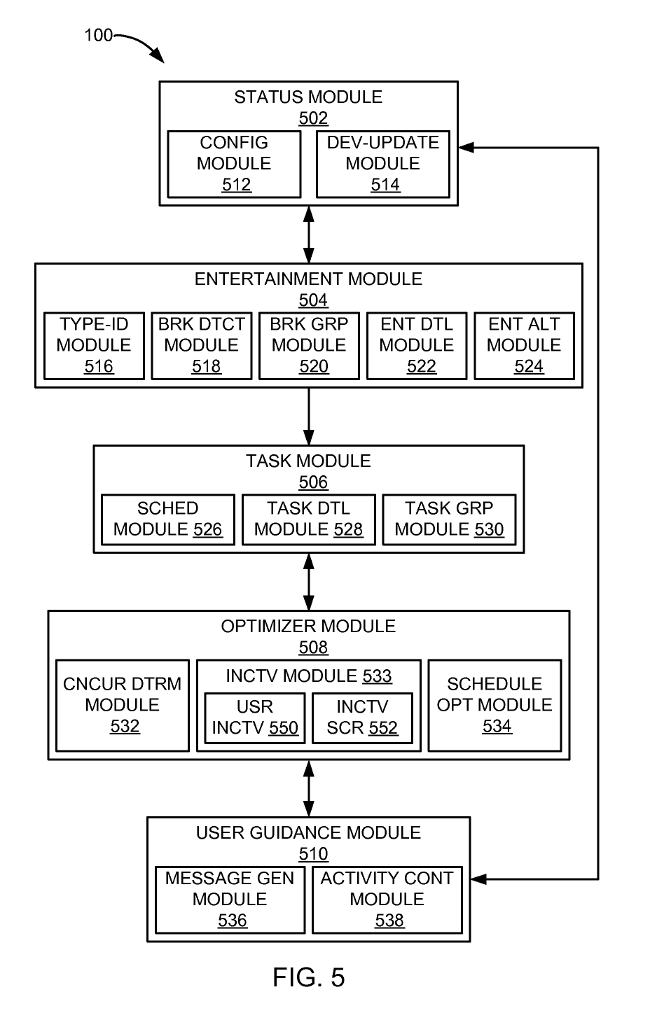

Referring now to FIG. 5, therein is shown a control flow for the entertainment system 100. The entertainment system 100 can have a status module 502, an entertainment module 504, a task module 506, an optimizer module 508, and a user guidance module 510.

The status module 502 can be coupled to the entertainment module 504, which can be further coupled to the task module 506. The task module 506 can also be coupled to the optimizer module 508, which can be further coupled to the user guidance module 510. The user guidance module 510 can also be coupled to the status module 502.

The status module 502 is for determining information regarding the surrounding environment. The status module 502 can configure the entertainment system 100 and determine the various statuses relevant to the entertainment system 100. The status module 502 can have a configuration module 512 and a device-update module 514 for determining the information regarding the surrounding environment.

The configuration module 512 is for configuring the entertainment system 100. The configuration module 512 can configure the entertainment system 100 by determining the system configuration map 302 of FIG. 3.

The configuration module 512 can determine the system configuration map 302 by using the first control unit 412 of FIG. 4, the second control unit 434 of FIG. 4, or a combination thereof to communicate with other devices. The configuration module 512 can communicate with devices, such as devices for engaging in the entertainment activity 204 of FIG. 2, the schedule task 230 of FIG. 2, or a combination thereof. The configuration module 512 can use the first communication unit 416 of FIG. 4, the second communication unit 436 of FIG. 4, or a combination thereof to communicate between devices.

The configuration module 512 can have the devices exchange various information, such as device identification, device type, device location or address, or a combination thereof. The configuration module 512 can use a predetermined protocol, as determined by a software provider, a hardware provider, the entertainment system 100, or a combination thereof to exchange and recognize various information.

The configuration module 512 can arrange the exchanged information according to a predetermined format to determine the system configuration map 302. The predetermine format can be set by the software provider, the hardware provider, the entertainment system 100, or a combination thereof. The configuration module 512 can store the system configuration map 302 in the first storage unit 414 of FIG. 4, the second storage unit 446 of FIG. 4, or a combination thereof.

The configuration module 512 can detect new devices for the entertainment system 100 by determining the system configuration map 302 at various times according to the predetermined protocol. For example, the configuration module 512 can determine the system configuration map 302 at regular time intervals, such as every hour or at a specified time each day. Also, for example, the configuration module 512 can determine the system configuration map 302 based on information broadcasted by the device for engaging in the entertainment activity 204, the schedule task 230, or a combination thereof during a power-on sequence of the new device.

The configuration module 512 can further determine and set the controlling device status 304 of FIG. 3 when there are multiple instances of the first device 102 of FIG. 1, multiple users, or a combination thereof. For example, the configuration module 512 can determine the controlling device status 304 based on identifying the first device 102 accessing the entertainment activity 204. The configuration module 512 can use information from the entertainment module 504 to identifying the first device 102 accessing the entertainment activity 204.

Also for example, the configuration module 512 can determine the controlling device status 304 by identifying attributes of the user. The configuration module 512 can analyze the input from the detection unit 420 of FIG. 4 to identify the user's presence, the direction user is facing, the user's identity, or a combination thereof detected through the detection unit 420.

Once the system configuration map 302 has been determined, the device-update module 514 can use the system configuration map 302 to determine various status information regarding the surrounding environment. The device-update module 514 is for receiving the device-status 224 of FIG. 2 from various devices including devices for engaging in the entertainment activity 204, such as the first device 102, the schedule task 230, such as the second device 106 of FIG. 1, or a combination thereof. The device-status 224 can be used to identify the various status information regarding the surrounding environment.

The device-update module 514 can use the first communication interface 428 of FIG. 4, the second communication interface 450 of FIG. 4, or a combination thereof to request, send, and receive the device-status 224 from each of the various devices. The device-update module 514 and the devices can follow the predetermined protocol to exchange the device-status 224.

The device-update module 514 can exchange the device-status 224 at various times according to the predetermined protocol. For example, each of the devices can be assigned a periodic time slot for communication in the system configuration map 302, with the periodic time slot used for broadcasting the device-status 224. Also, for example, each of the devices start interacting with a specific device, such as the first device 102, to acquire a time slot to transmit the device-status 224 upon detecting a change in state or status in the transmitting device.

The control flow can pass from the status module 502 to the entertainment module 504 after determining the system configuration map 302 and the device-status 224. The entertainment module 504 is for identifying and processing information related to the entertainment activity 204.

The entertainment module 504 can identify the entertainment activity 204 by identifying the source of the content for any activity. The entertainment module 504 can identify the source of the content by comparing the access method or physical source of the content on the first device 102.

For example, the entertainment module 504 can identify that information received through a particular auxiliary port coupled to a dedicated game console is always content for the entertainment activity 204. Also, for example, the entertainment module 504 can compare the internet address providing the video content to a list of addresses for known entertainment provider list. The known provider list can be determined by the software or hardware manufacture, by the entertainment system 100, using available information on the internet, or a combination thereof.

The entertainment module 504 can identify the entertainment activity 204 by analyzing the content on the first device 102. For example, the entertainment module 504 can compare the title, the genre, the rating, identification information, the content itself, such as a sequence of notes or a picture, featured characters, or a combination thereof to known lists. Known lists for matching analyzed content information can be determined by the software or hardware manufacture, by the entertainment system 100, using available information on the internet, or a combination thereof.

The entertainment module 504 can identify the content on the first device 102 as pertaining to the entertainment activity 204 when the source information or the content analysis matches a known entertainment content. The entertainment module 504 can pass the determination back to the status module 502 for determining the controlling device status 304. Further, the entertainment module 504 can directly pass the control flow to the task module 506 when the content is not related to the entertainment activity 204.

When the content is related to the entertainment activity 204, the entertainment module 504 can process the information related to the entertainment activity 204 using various sub-modules. The entertainment module 504 can have a type-identification module 516, a break detection module 518, a break grouping module 520, an entertainment detail module 522, and an entertainment alternative module 524 for processing the information related to the entertainment activity 204.

The type-identification module 516 is for identifying the entertainment input type 206 of FIG. 2. The entertainment input type 206 can be used to classify the entertainment activity 204 involving or facilitated by the first device 102. The type-identification module 516 can determine the source or analyzed the content for the entertainment activity 204 as described above.

For example, content received over specified frequencies, such as television frequencies or AM radio frequencies, can be identified as the externally-controlled type 214 of FIG. 2. Also for example, the type-identification module 516 can determine content having video format processed directly from the first communication unit 416 or the second communication unit 436 as the externally-controlled type 214 and information from the first storage unit 414 or the second storage unit 446 as the locally-controlled type 212 of FIG. 2.

For further example, the type-identification module 516 can analyze the content for studio, distributor, developer, manufacturer, or a combination thereof information contained therein to produce an analyzed result. The type-identification module 516 can compare the analyzed result to a known list identifying console game developers, digitally stored movie or show distributor or providers, or a combination thereof. The type-identification module 516 can identify the content as the locally-controlled type 212 when the analyzed result matches the known list.

It has been discovered that the entertainment input type 206 having the locally-controlled type 212 and the externally-controlled type 214 as possible values enables detailed analysis and limited boundary for providing accuracy and efficiency. The entertainment system 100 can select or limit the type of analysis based on the entertainment input type 206, which can provide the accurate optimization results using fewer iterations or inputs.

The break detection module 518 is for detecting the entertainment break period 208 of FIG. 2. The break detection module 518 can detect the entertainment break period 208, the entertainment segments 205 of FIG. 2, or a combination thereof based on the entertainment input type 206. The break detection module 518 can detect the entertainment break period 208 as being readily available when the entertainment input type 206 is the locally-controlled type 212.

The break detection module 518 can also detect the entertainment break period 208, the entertainment segments 205, or a combination thereof for the externally-controlled type 214. The break detection module 518 can detect the entertainment break period 208, the entertainment segments 205, or a combination thereof by analyzing the content for the entertainment activity 204.

For example, the break detection module 518 can receive a signal identifying the currently portions of the content as a commercial or as being part of the entertainment segments 205. Also for example, the break detection module 518 can analyze the content, such as by identifying the faces and cross-checking with the list of the cast and their matching their pictures to the identified faces or by analyzing the picture format or quality.

Scheduling for the entertainment break period 208 can also be integrated in the programming schedule for the externally-controlled type 214. The break detection module 518 can detect the entertainment break period 208 from such programming schedule.

Instances of the entertainment break period 208 can be grouped to form the break-period grouping 218 of FIG. 2. The break grouping module 520 is for calculating the break-period grouping 218 having the entertainment break period 208.

The break grouping module 520 can calculate the break-period grouping 218 by using the first control unit 412, the second control unit 434, or a combination thereof to identify sequential instances of the entertainment break period 208 that are tied to the same content. For example, the break grouping module 520 can calculate the commercials or station identification occurring between segments within a show or a movie as the break-period grouping 218.

The entertainment module 504 can process historical information and determine detail information regarding the entertainment activity 204. The entertainment detail module 522 can process historical information by storing the entertainment history 216 of FIG. 2. The entertainment detail module 522 can store the date and time of the entertainment activity 204, the entertainment input type 206, the title, genre, duration, rating or other identification information for the entertainment activity 204, the characters, cast, type, picture quality, or other content related information, or a combination thereof.

The entertainment detail module 522 can analyze the entertainment history 216 to determine the entertainment priority 210 of FIG. 2 using a variety of methods. For example, the entertainment detail module 522 can determine the entertainment priority 210 using the number of times a particular show or series has been watched, the number of times the particular show or series has been available, or a combination thereof. Also for example, the entertainment detail module 522 can use the number of times an entertainment content is accessed between a particular time segment during the weekdays, over the weekend, or a combination thereof.

For further example, the entertainment detail module 522 can detect patterns using the entertainment history 216. The entertainment detail module 522 can determine the patterns to be user preferences. The entertainment detail module 522 can use the user preferences and other available information, such as the user's rating or the number of views, to determine the entertainment priority 210.

In yet another example, the entertainment detail module 522 can use statistical analysis and pattern analysis to determine the schedule task 230 most likely to be completed in concurrence with or during the entertainment break period 208 of the entertainment activity 204. Patterns and correlations can be used to evaluate a likelihood or a score indicating a likelihood that the user will complete the schedule task 230 can be calculated from the entertainment history 216. The likelihood or the score can be used by the entertainment system 100 in calculating the adjusted entertainment schedule 310.

It has been discovered that the entertainment priority 210 and the entertainment detail module 522 provide scheduling that best models the user's preferences and openness to distractions regarding the entertainment activity 204. The entertainment priority 210 and the entertainment detail module 522 provide the scheduling benefit by providing quantized and measurable parameter enabling comparisons and measurements related to optimization methods.

The entertainment detail module 522 can also determine the entertainment priority 210 based on the entertainment input type 206. The entertainment detail module 522 can determine the entertainment priority 210 by assigning higher importance to the externally-controlled type 214 since the externally-controlled type 214 is not readily available. The entertainment detail module 522 can also determine the entertainment priority 210 by adjusting the entertainment priority 210 of the locally-controlled type 212 to have lesser importance or preference than the originally determined value.

The entertainment module 504 can also identify an alternative time, source, or a combination thereof for engaging the entertainment activity 204. The entertainment alternative module 524 is for identifying the substitute availability 306 of FIG. 3 for engaging in the entertainment activity 204.

The entertainment alternative module 524 can identify the substitute availability 306 for the locally-controlled type 212 as being readily available when the entertainment input type 206 is the locally-controlled type 212. The entertainment alternative module 524 can set the substitute availability 306 as a specific value representing accessibility at any time and store the substitute availability 306 in the first storage unit 414, the second storage unit 446, or a combination thereof.

The entertainment alternative module 524 can also identify the substitute availability 306 for the externally-controlled type 214. The entertainment alternative module 524 can use the first communication unit 416, the second communication unit 436 or a combination thereof to search various databases and content provider information to find the substitute availability 306. For example, the entertainment alternative module 524 can search various sources, such as internet content providers or network programming schedules, for the availability information for specified shows or the time and channel for rebroadcasting of the specified show.

The entertainment alternative module 524 can use the first control unit 412, the second control unit 434, or a combination thereof to arrange the acquired information for identifying the substitute availability 306. For example, the entertainment alternative module 524 can group a combination of identification of the specified show, source for the specified show, and accessible time for the specified show as the substitute availability 306.

It has been discovered that the entertainment alternative module 524, the substitute availability 306, the entertainment priority 210, and the task priority 240 of FIG. 2 provide increased scheduling possibilities with accurate modeling of the user's preferences. The substitute availability 306, the entertainment priority 210, and the task priority 240 provide the scheduling benefit by identifying various choices that the user will consider in balancing the task and entertainment activities.

The task module 506 is for identifying the schedule list 220 of FIG. 2, the schedule task 230, and related information. The task module 506 can have a schedule module 526, a task detail module 528, and a task grouping module 530 for the identification function.

The task module 506 can detect and receive the schedule list 220. The task module 506 can detect and receive the schedule list 220 by synchronizing with the user's calendar application. The task module 506 can download the contents of the user's calendar as the schedule list 220. The individual entries within the calendar application can be individual instances of the schedule task 230.

The task module 506 can further expand the schedule list 220 to include other activities. The schedule module 526 is for managing the schedule task 230. The schedule module 526 can manage the schedule task 230 by determining a new instance of the schedule task 230 for suggesting to the user.

The schedule module 526 can determining the new instance of the schedule task 230 based on time and time associated activities that are missing from the schedule list 220. For example, the task module 506 can determine that the schedule task 230 of preparing and eating dinner when none of the entries in the schedule list 220 include food related information between 4:00 pm to 9:00 pm. Also, for example, the task module 506 can determine that the schedule task 230 of doing the laundry can be determined based on the current time being Saturday afternoon.

The schedule module 526 can also use other information from the schedule list 220 to determine the new instance of the schedule task 230. For example, the schedule module 526 can detect and use patterns, time since last similar task, time before next similar task, time between tasks, or a combination thereof.

The schedule module 526 can further use the device-status 224 to determine the new instance of the schedule task 230. For example, the schedule module 526 can determine the new instance of the schedule task 230 to check the email based on an email application on the first device 102 or call the repair service based on the device-status 224 from the second device 106. Also for example, the schedule module 526 can determine cooking a specific meal based on available resources, such as the number of usable stove slots or possible ingredients in the refrigerator.

The schedule module 526 can also manage the schedule task 230 by determining the task context 234 of FIG. 2 for overlapping the schedule task 230 with the entertainment break period 208. The schedule module 526 can determine the task context 234 of the schedule task 230. The schedule module 526 can determine the task context 234 by analyzing the information in the schedule task 230, such as the title or the participant, for associations to known list of contexts predetermined by the entertainment system 100, the software or hardware manufacturer, or a combination thereof.

For example, the schedule module 526 can use a statistical model using the words associated with the schedule task 230 or the scheduled time slot of the schedule task 230 in comparison to the known list to determine the task context 234. Also for example, the schedule module 526 can also use historical data in the schedule list 220, relationship of the user with participants, a location of the first device 102, a location of the second device 106, or a combination thereof to determine the task context 234.

For a more specific example, the schedule module 526 can determining the task context 234 from a home related set of activities and contexts when the first device 102 is located at home and using home related entries, patterns, or correlations in the entertainment history 216. The context and the related activities at certain locations, such as home and work, can have unique set of activities, such as laundry or certain work activities. The schedule module 526 can determining the task context 234 account for the uniqueness and the resulting patterns by considering location information as well as the entertainment history 216.

The task context 234 can be used for overlapping the schedule task 230 with the entertainment activity 204. The task context 234 can be compared to the entertainment input type 206, the substitute availability 306, the entertainment priority 210, or a combination thereof to overlap the schedule task 230 with the entertainment activity 204. Details regarding the overlapping process will be described below.

The schedule module 526 can further manage the schedule task 230 by determining the task-completion status 242 of FIG. 2 for completing the schedule task 230. The schedule module 526 can use the detection unit 420 to determine whether the user has completed the schedule task 230. The schedule module can also use the device-status 224 to compare with various device interactions required to perform the schedule task 230.

The schedule module 526 can determining the task-completion status 242 by setting the flag or assign the value representing that the schedule task 230 has been completed to a register or a variable. The schedule module 526 can determining the task-completion status 242 when the information from the detection unit 420, the device-status 224, or a combination thereof matches all of the comparable information related to the schedule task 230.

The task detail module 528 is for determining detailed information regarding the schedule task 230. The task detail module 528 can determine the task priority 240 for temporally overlapping the schedule task 230 with the entertainment break period 208.

The task detail module 528 can determine the task priority 240 based on the task context 234. The task detail module 528 can compare the task context 234 to a predetermined grouping of contexts and their corresponding priority levels.

For example, the predetermined grouping can have meal related activities, such as cooking and eating, at medium priority. Also, for example, the predetermined grouping can have any activities having direct safety concerns, such as using the oven or stove or closing the garage door, to an increased level of priority. The task detail module 528 can determine the task priority 240 by setting the value to the corresponding priority levels of the predetermined grouping.

The task detail module 528 can determine the task priority 240 based on the task context 234 of FIG. 2 corresponding to other participants. For example, the task detail module 528 can assign lowest values for the task priority 240 when regarding phone calls from unknown numbers or known telemarketers. Also for example, the task detail module 528 can assign or adjust the task priority 240 to a higher number for reading certain emails based on urgency flag being set, key words indicating urgency or emergency, sender's identification or title, such as work boss or daycare service provider, or a combination thereof.

The task detail module 528 can also determine the task priority 240 based on the second device 106 or the device-status 224 thereof. The task detail module 528 can have a list of priority values assigned to various types of devices. For example, a breach status of an alarm system or any status from a fireplace can have a high value, or a received email status without any urgent status or without any key words, such as ‘urgent’ or ‘immediate’ can have a low priority.

It has been discovered that the task priority 240 and the task detail module 528 provide scheduling that best models the user's preferences and openness to distractions regarding the entertainment activity 204 and the schedule task 230. The task priority 240 and the task detail module 528 provide the scheduling benefit by providing quantized and measurable parameter enabling comparisons and measurements related to optimization methods.

The task grouping module 530 is for determining the task grouping 236 of FIG. 2 corresponding to the task context 234 for overlapping the break-period grouping 218. The task grouping module 530 can search the schedule list 220 for instances of the schedule task 230 having the same or related instances of the task context 234. The task grouping module 530 can determine instances of the schedule task 230 having the same or related instances of the task context 234 as the task grouping 236.

The optimizer module 508 is for calculating a time slot for the schedule task 230 or the task grouping 236 to coincide and overlap with the entertainment activity 204, the entertainment break period 208, or a combination thereof. The optimizer module 508 can calculate the time slot by calculating the adjusted entertainment schedule 310 of FIG. 3. The optimizer module 508 can have a concurrence determination module 532, an incentive module 533, and a schedule optimization module 534 for calculating the adjusted entertainment schedule 310.

The concurrence determination module 532 is for identifying the entertainment-concurrent task 232 of FIG. 2 having the sequential connection 238 of FIG. 2 to instances of the schedule task 230. The concurrence determination module 532 can identify the entertainment-concurrent task 232 by comparing each of the schedule task 230 to the concurrent activity set 308 of FIG. 3 stored in the first storage unit 414, the second storage unit 446, or a combination thereof.

The concurrence determination module 532 can use the first control unit 412, the second control unit 434, or a combination thereof to compare each instance of the schedule task 230 to the concurrent activity set 308. The concurrence determination module 532 can identify the entertainment-concurrent task 232 when the schedule task 230 or the task context 234 thereof matches an entity in the concurrent activity set 308.

The concurrence determination module 532 can use the first control unit 412, the second control unit 434, or a combination thereof to set a status or identification for the schedule task 230 to identify it as the entertainment-concurrent task 232. The concurrence determination module 532 can store the identification for the entertainment-concurrent task 232 in the first storage unit 414, the second storage unit 446, or a combination thereof.

It has been discovered that the concurrence determination module 532, the concurrent activity set 308, and the entertainment-concurrent task 232 provide increased scheduling possibilities and more efficient scheduling results. The concurrence determination module 532, the concurrent activity set 308, and the entertainment-concurrent task 232 provide the scheduling benefits by enabling and calculating for simultaneous activities.

The concurrence determination module 532 can further identify the entertainment-concurrent task 232 having the sequential connection 238 to a different instance of the schedule task 230. The concurrence determination module 532 can use the concurrent activity set 308, the task context 234, or a combination thereof to identify the sequential connection 238 between tasks.

The concurrent activity set 308 can have a sequential order, a relative time window, or a combination thereof for the entertainment-concurrent task 232 relative to other tasks. For example, the concurrent activity set 308 can have preparing food ingredients at least half hour before a marinating step or any time before turning on the stove for cooking the ingredients. Also for example, the concurrent activity set 308 can have folding the laundry after the dryer finishes running the dry cycle.

The concurrence determination module 532 can search the schedule list 220 for an instance of the schedule task 230 corresponding to the sequential order, the relative time window, or a combination thereof in the concurrent activity set 308. The concurrence determination module 532 can identify the sequential connection 238 for the entertainment-concurrent task 232 by linking the entertainment-concurrent task 232 with the instance of the schedule task 230 matching the sequential order in the concurrent activity set 308.

The concurrence determination module 532 can notify the task module 506 through a flag or a return value when no instances in the schedule list 220 matches the sequential order in the concurrent activity set 308. The task module 506 can add a new instance of the schedule task 230 in the schedule list 220 based on the sequential order, the relative time window, or a combination thereof.

The schedule list 220 having instances of the schedule task 230, the entertainment-concurrent task 232, or a combination thereof in the task grouping, each of the instances with the task context 234, the task priority 240, the sequential connection, or a combination thereof can be passed to the schedule optimization module 534. After or in parallel to the operations of the schedule module concurrence determination module 532, the incentive module 533 can identify a user incentive 550 and an incentive score 552 related to the user incentive 550.

The user incentive 550 is defined as an additional content or accessibility related to the entertainment activity 204 available based on the user's physical actions. The user incentive 550 can become available to the user when the entertainment system 100 determines the user to act according to a satisfying condition of the user incentive 550.

For example, the user incentive 550 can have the satisfying condition of the user following the adjusted entertainment schedule 310 for a minimum duration of time. Also for example, the user incentive 550 can have the satisfying condition of performing instances of the schedule task 230, the entertainment-concurrent task 232, or a combination thereof in a specific order or within a specified amount of time.

The user incentive 550 can have a message for notifying the user of the satisfying condition of the user incentive 550. The entertainment system 100 can communicate, including displaying, the message of the user incentive 550 using the first user interface 418, the second user interface 438 or a combination thereof.

The user incentive 550 can also have a reward for meeting the satisfying condition. The user incentive 550 can have hardware instructions, accessibility information, additional content information, access information for the additional content, or a combination thereof as the reward.

For example, the user incentive 550 can have the reward to unlock hidden levels, side quests, or additional tools and items for a game when the user is determined to have completed all school related instances of the schedule task 230 for a month. Also for example, the user incentive 550 can have additional content, such as behind-the-scene footage or content from corresponding sound track, or accessibility information for the additional content as the reward.

It has been discovered that the user incentive 550 provides added motivation for the user and increased efficiency in managing time. The user incentive 550 provides the added motivation and increased efficiency by allowing user to access portions of the entertainment activity 204 based on following the adjusted entertainment schedule 310.

It has also been discovered that the user incentive 550 provides user interactions activities in the physical world to have increased significance and correlation to the entertainment activity 204. The user incentive 550 provides real-life user interactions by having the completion of the schedule task 230, the entertainment-concurrent task 232, or a combination thereof influence the entertainment activity 204.

For example, the user incentive 550 can be used to integrate a video game with house chores. Also for example, user incentive 550 can enable the entertainment system 100 to implement “choose your own adventure” type of interaction with a movie or a show using user's physical activity and not limited to user interactions through the first user interface 418 or the second user interface 438.

The incentive module 533 can determine the user incentive 550 by identifying the reward associated with the entertainment activity 204, determining the satisfying condition, and generating the message. The incentive module 533 can identify the reward of the user incentive 550 by accessing details regarding the entertainment activity 204.

For example, the incentive module 533 can use the first control unit 412, the second control unit 434, the first communication unit 416, the second communication unit 436, or a combination thereof to access a database or a catalog corresponding to the entertainment activity 204. The incentive module 533 can set access information or additional instructions ding to the entertainment activity 204 in the database or the catalog as the reward for the user incentive 550.

The incentive module 533 can determine the satisfying conditions as performing the schedule task 230, the entertainment-concurrent task 232, or a combination thereof. The incentive module 533 can use the device-status 224, the task-completion status 242, user information recognizable through the detection unit 420 and related to the adjusted entertainment schedule 310, or a combination thereof as the satisfying conditions.

The incentive module 533 can determine the satisfying conditions to tie the user incentive 550 to multiple instances of the schedule task 230, the entertainment-concurrent task 232, or a combination thereof. The incentive module 533 can also determine the satisfying conditions to tie the user incentive 550 to incentivize the user to complete tasks having low likelihood of completing, high priority, or a combination thereof.

The incentive module 533 can generate the message for communicating the user incentive 550. The incentive module 533 can generate the message by combining strings or key words associated with the reward and the now corresponding task.

It has been discovered that the user incentive 550 determined by the incentive module 533 provides increased efficiency in managing the user's time. The user incentive 550 determined by the incentive module 533 provides increased efficiency by dynamically determining the user incentive 550 using real-time information and relevant current schedule information to motivate the user.

The incentive module 533 can further calculate the incentive score 552 corresponding to the user incentive 550. The incentive score 552 is defined as an estimated effectiveness of the user incentive 550. The incentive score 552 can be a percentage, a score, a rating, or a combination thereof indicating the increase in likelihood of the user performing an instance of the task.

The incentive module 533 can calculate the incentive score 552 by calculating an affinity of the user for the reward, likelihood of performing the task, or a combination thereof. The incentive module 533 can use the entertainment history 216, user's other physical behaviors, or a combination thereof to calculate the affinity, the likelihood, or the combination thereof. The incentive module 533 can perform statistical analysis or use equations or methods predetermined by the entertainment system 100, the hardware manufacturer, the software designer, or a combination thereof to calculate the incentive score 552.

It has been discovered that the user incentive 550 and the incentive score 552 provide user-specific optimization plan that the user is more likely to follow. The user incentive 550 and the incentive score 552 provide customization and increased likelihood by using the user's own behavior to determine the effectiveness of the user incentive 550, which can be further accounted for during the calculation of the optimization plan.

The user incentive 550 and the incentive score 552 can also be passed to the schedule optimization module 534. The schedule optimization module 534 is for calculating a schedule for optimizing the user's time regarding the user's activities. The schedule optimization module 534 can optimize by calculating the adjusted entertainment schedule 310 for engaging in the entertainment activity 204 and the schedule task 230.

The schedule optimization module 534 can calculate the adjusted entertainment schedule 310 based on comparing the schedule task 230 to the entertainment break period 208. The schedule optimization module 534 can calculate the adjusted entertainment schedule 310 by calculating various orderings of the contents in the schedule list 220. The schedule optimization module 534 can use inherent time related or sequence related requirements as boundary constraints in ordering the contents.

The schedule optimization module 534 can use various arrangements or scheduling. The schedule optimization module 534 can overlap the schedule task 230 with the entertainment break period 208, the entertainment-concurrent task 232 with the entertainment activity 204 or portions thereof, or a combination thereof in ordering the contents.

The schedule optimization module 534 can use optimization methods, such as metaheuristic method or constraint satisfaction, an ordering logic set or rules, example ordering, or a combination thereof to calculate the adjusted entertainment schedule 310. The schedule optimization module 534 can use the boundary constraints and the overlapping rules as described above for calculating the adjusted entertainment schedule 310. The schedule optimization module 534 can also use the entertainment input type 206, the entertainment priority 210, the task context 234, the task priority 240, or a combination thereof as an input or a score for calculating the adjusted entertainment schedule 310.

The schedule optimization module 534 can also calculate the adjusted entertainment schedule 310 based on the substitute availability 306. The schedule optimization module 534 can use the substitute availability 306 when the entertainment activity 204 is the externally-controlled type 214, the optimization process fails to converge on a solution set, or a combination thereof.

When the optimization process fails to find the adjusted entertainment schedule 310, the schedule optimization module 534 can further signal the task module 506 to replace the schedule task 230 or the task grouping 236 with another similar activity having the same value for the task context 234. The schedule optimization module 534 can repeat the optimization process with the new instance of the schedule task 230 or the task grouping 236. The replacement of the schedule task 230 or the task grouping and the optimization process can repeat up to a predetermined number of cycles or until the adjusted entertainment schedule 310 is found.

For example, the schedule optimization module 534 can notify the task module 506 when cooking spaghetti and watching an important sporting event cannot be scheduled together. The task module 506 can replace cooking spaghetti with heating up canned soup or left over food, both sets of tasks having the same value for the task context 234 of cooking.

The schedule optimization module 534 can select the schedule task 230 using the current location of the first device 102, the second device 106, or a combination thereof. The schedule optimization module 534 can determine the schedule task 230 from the groupings, patterns, or correlations associated to certain locations, such as home or work, when the current location of the first device 102 matches the certain locations. The schedule optimization module 534 can also select the schedule task 230 involving the second device 106 having the current location thereof within a threshold proximity to the current location of first device 102.

Subsequently, the schedule optimization module 534 can alter the selection of the schedule task 230 to recalculate the adjusted entertainment schedule 310 as the user changes location. The changes in the current location of first device 102 can prompt the schedule optimization module 534 to reselect the schedule task 230 based on the current location of the first device 102 using a method similar to the one described above.

The schedule optimization module 534 can further select the schedule task 230 and calculate the adjusted entertainment schedule 310 based on the user incentive 550 and the incentive score 552. The schedule optimization module 534 can calculate the adjusted entertainment schedule 310 by selecting the schedule task 230 having the most instances of the user incentive 550 or the highest value, highest average or combined value of the incentive score 552.

The schedule optimization module 534 can analyze the average or estimated time required to complete the schedule task 230. The schedule task 230 can have average estimated time associated with the activity. The schedule optimization module 534 can calculate and determine the average or estimated time using the entertainment history 216 and associated user behavior information. The schedule optimization module 534 can further access data bases or gather other relevant information to analyze the average or estimated time.

The schedule optimization module 534 can calculate the adjusted entertainment schedule 310 by having the estimated or average completion time of the schedule task 230 be less than or equal to the entertainment break period 208. The schedule optimization module 534 can also calculate the adjusted entertainment schedule 310 by having the estimated or average completion time of the schedule task 230 exceed the entertainment break period 208 by a predetermined amount based on the entertainment priority 210.

The schedule optimization module 534 can calculate the adjusted entertainment schedule 310 based on the likelihood or the score indicating the likelihood that the user will complete the schedule task 230. For example, the schedule optimization module 534 can select the schedule task 230, the entertainment-concurrent task 232, or a combination thereof having the highest value of the likelihood or the score. Also for example, the schedule optimization module 534 can eliminate the schedule task 230, the entertainment-concurrent task 232, or a combination thereof having the value of the likelihood or the score less than a predetermined threshold amount.

The schedule optimization module 534 can further adjust the likelihood or the score from the entertainment detail module 522. The schedule optimization module 534 can adjust by determining patterns and correlations of various possible instances of the schedule task 230 and the type, the category, or the instance of the entertainment activity 204 or the entertainment priority 210.

The schedule optimization module 534 can perform statistical analysis using the various possible instances of the schedule task 230 and the type, the category, or the instance of the entertainment activity 204 or the entertainment priority 210 using the entertainment history 216. The schedule optimization module 534 can adjust by combining the likelihood or the score from the entertainment detail module 522 with the cross-analyzed result.

The schedule optimization module 534 can further adjust the likelihood or the score based on priorities or types of activities and tasks the user has performed during the day or within a threshold amount of time. For example, the schedule optimization module 534 adjust the likelihood or the score of the tasks having low priority, high complexity, least often performed, or a combination thereof to be less likely when the user has had a day filled with high priority tasks or activities or has recently performed a work-related activity on a weekend.

The schedule optimization module 534 can have a process, an equation, a table, or a combination thereof predetermined by the entertainment system 100, the hardware manufacturer, the software manufacture or a combination thereof that can calculate the adjusted entertainment schedule 310. The schedule optimization module 534 can use the likelihood or the score, along with the various other factors and elements discussed above, as an input to the process, the equation, the table, or the combination thereof.

It has been discovered that the task context 234, the task module 506, and the schedule optimization module 534 provide increased choices resulting in further optimization of the adjusted entertainment schedule 310. The task context 234, the task module 506, and the schedule optimization module 534 provide the scheduling benefit by categorizing various choices of the schedule task 230, which enables swapping instances of the schedule task 230 in the user's schedule for instances that better optimize the user's time while providing the same category of task.

It has also been discovered that the adjusted entertainment schedule 310 based on the entertainment input type 206, the entertainment priority 210, the substitute availability 306, the break-period grouping 218, the task context 234, the task priority 240, the entertainment-concurrent task 232, the task grouping 236, the concurrent activity set 308, the device-status 224, or a combination thereof provide accurate and more efficient use for the user's time. The adjusted entertainment schedule 310 provides the scheduling benefit by providing the result of optimizing the user's time using numerous considerations and scenarios.

After calculating the adjusted entertainment schedule 310, the control flow can pass to the user guidance module 510. The user guidance module 510 is for suggesting an optimized way to engage in both the entertainment activity 204 and the schedule task 230 or sequences of both the entertainment activity 204 and the schedule task 230. The user guidance module 510 can suggest the optimized way by generating the task-suggestion 226 of FIG. 2. The user guidance module 510 can have a message generator module 536 and an activity continuation module 538 for generating the task-suggestion 226.

The message generator module 536 is for generating the task-suggestion 226 for suggesting the schedule task 230, the entertainment-concurrent task 232, or a combination thereof for displaying on the first device 102. The message generator module 536 can generate the task-suggestion 226 by organizing contents of the schedule task 230 or the entertainment-concurrent task 232 for graphically displaying the contents.

For example, the message generator module 536 can use predetermine header or connector language, such as ‘please consider’ or ‘URGENT!’, the title or participants of the schedule task 230, the task context 234, or a combination thereof to generate the task-suggestion 226. Also for example, the message generator module 536 can use the task context 234, the task priority 240, the sequential connection 238, or a combination thereof to determine the arrangement of the content within the task-suggestion 226.

After organizing the contents, the message generator module 536 can generate the task-suggestion 226 by displaying the task-suggestion 226 based on the adjusted entertainment schedule 310. The message generator module 536 can compare the adjusted entertainment schedule 310 to the current time or upon detecting the entertainment break period 208 by the break detection module 518 for the externally-controlled type 214.

The message generator module 536 can use the first control unit 412, the second control unit 434, or a combination thereof to organize the task-suggestion 226. The message generator module 536 can display the task-suggestion 226 on the first user interface 418 of FIG. 4, the second user interface 438 of FIG. 4, or a combination thereof.

The message generator module 536 can identify the interruption scenario 222 of FIG. 2 for interrupting the entertainment activity 204. The message generator module 536 can compare the task priority 240 of instances of the schedule task 230 or the entertainment-concurrent task 232 overlapping or adjacent in time with the entertainment activity 204 to the entertainment priority 210.

The message generator module 536 can identify the interruption scenario 222 based on rules or conditions. For example, the message generator module 536 can identify the interruption scenario 222 when the task priority 240 is at a maximum level, greater than the entertainment priority 210, the entertainment priority 210 is lower than a threshold level, or a combination thereof. The message generator module 536 can generate the task-suggestion 226 during the entertainment activity 204 when the interruption scenario 222 is identified without waiting for the entertainment break period 208.

The message generator module 536 can generate the schedule update 228 of FIG. 2 based on the device-status 224. The message generator module 536 can organize the content of the schedule update 228 similar to organizing the content of the task-suggestion 226 using the device-status 224 for the schedule task 230 or the entertainment-concurrent task 232 already in progress. The message generator module 536 can display the device-status 224 similar to the task-suggestion 226.

The message generator module 536 can further display a message related to the user incentive 550 on the first device 102. The message generator module 536 can motivate the user to optimize the user's time by following the task-suggestion 226 according to the adjusted entertainment schedule 310 through the user incentive 550. The message generator module 536 can display the user incentive 550, along with the task-suggestion 226, on the first user interface 418, the second user interface 438, or a combination thereof using the first control unit 412, the second control unit 434, or a combination thereof.

The activity continuation module 538 is for setting the entertainment-continuation status 244 of FIG. 2 based on the task-completion status 242 for continuing the entertainment activity 204. The activity continuation module 538 can require certain tasks to be completed before allowing the user to continue with the entertainment activity 204.

For example, the entertainment system 100 can disable user interfaces, ignore user inputs for the entertainment activity 204 based on the entertainment-continuation status 244. Also for example, the entertainment system 100 can have the entertainment activity 204 paused, have the display altered, such as by graying or displaying a pop up, or control the content, such as by not restarting the entertainment activity 204 or by not downloading the content, based on changes in the entertainment-continuation status 244.

The activity continuation module 538 can check for the task-completion status 242 at the end of the entertainment break period 208. The activity continuation module 538 can prevent the user from re-engaging in the entertainment activity 204, such as by dimming the display, not removing the task-suggestion 226, ignoring certain user inputs, or a combination thereof when the task-completion status 242 indicates that the schedule task 230 is not finished.

The activity continuation module 538 can also implement the user incentive 550. The activity continuation module 538 can use the detection unit 420 to detect the user behavior. The activity continuation module 538 can use the first control unit 412, the second control unit 434, or a combination thereof to analyze and determine the user behavior.

When the analyzed and determined behavior matches the satisfying condition for the user incentive 550, the activity continuation module 538 can implement the user incentive 550. The activity continuation module 538 can implement the user incentive 550 by carrying out the reward associated with the user incentive 550. For example, the activity continuation module 538 can download content, such as behind the scene or gag reel, or unlock hidden quests or levels in a game when the user follows the conditions of the user incentive 550 according to the adjusted entertainment schedule 310.

The activity continuation module 538 can store the analyzed and determined behavior relative to the adjusted entertainment schedule 310 and the task-completion status 242 in the first storage unit 414, the second storage unit 446, or a combination thereof as part of the entertainment history 216. The activity continuation module 538 can also store the analyzed and determined behavior relative to the user incentive 550 in the first storage unit 414, the second storage unit 446, or a combination thereof as part of the entertainment history 216.

The physical transformation of the adjusted entertainment schedule 310, such as through displaying the task-suggestion 226, results in movement in the physical world, such the user engaging in the schedule task 230. The movement in the physical world can be fed back to the entertainment system 100 to further operate the entertainment system 100.

Also, the physical transformation of the entertainment-continuation status 244, such as physical disabling of the functionalities related to the entertainment activity 204, results in movement in the physical world, such as the user interfacing with other devices for completing the schedule task 230. The movement in the physical world can be fed back to the entertainment system 100 to further operate the entertainment system 100.

It is understood that the various modules described above can be implemented as hardware in the first control unit 412, the second control unit 434, or both. The different modules can also be implemented as separate hardware mechanism, circuit, or device (not illustrated) in the first device 102, the second device 106, or a combination thereof.

It is further understood that the various modules are for illustrative purposes and can be partitioned differently. For example, the task module 506 can be combined with the optimizer module 508. Also for example, the interruption scenario 222 can be determined by the task module 506.

Also for illustrative purposes, the first device 102 is described as performing most of the above described methods. However, it is understood that the method can be shared with the second device 106. For example, the second device 106 can calculate the adjusted entertainment schedule 310 or determine the task priority 240.

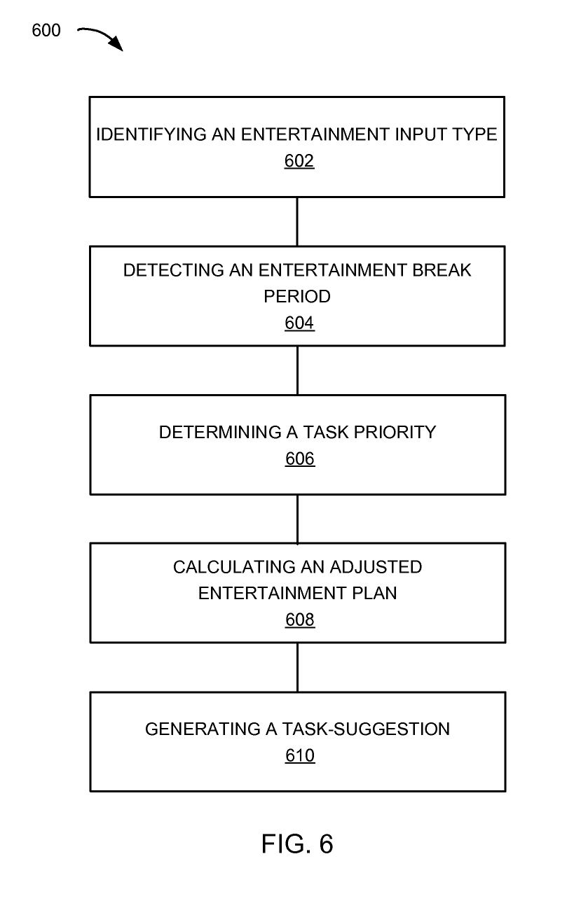

Referring now to FIG. 6, therein is shown a flow chart of a method 600 of operation of an entertainment system in a further embodiment of the present invention. The method 600 includes: identifying an entertainment input type for classifying an entertainment activity in a block 602; detecting an entertainment break period based on the entertainment input type in a block 604; determining a task priority for temporally overlapping a schedule task with the entertainment break period in a block 606; calculating an adjusted entertainment schedule based on the task priority for engaging in the entertainment activity and the schedule task in a block 608; and generating a task-suggestion based on the adjusted entertainment schedule for displaying on a device in a block 610.

Yet other important aspects of the embodiments include that it valuably supports and services the historical trend of reducing costs, simplifying systems, and increasing performance.

These and other valuable aspects of the embodiments consequently further the state of the technology to at least the next level.

Thus, it has been discovered that the entertainment system of the present invention furnishes important and heretofore unknown and unavailable solutions, capabilities, and functional aspects for improving reliability in systems. The resulting processes and configurations are straightforward, cost-effective, uncomplicated, highly versatile, and effective, can be implemented by adapting known technologies, and are thus readily suited for efficiently and economically manufacturing entertainment system.

Another important aspect of the present invention is that it valuably supports and services the historical trend of reducing costs, simplifying systems, and increasing performance.

These and other valuable aspects of the present invention consequently further the state of the technology to at least the next level.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters hithertofore set forth herein or shown in the accompanying drawings are to be interpreted in an illustrative and non-limiting sense.

What is claimed is:

1. A method of operation of an entertainment system comprising:
identifying an entertainment input type for classifying an entertainment activity;
detecting an entertainment break period based on the entertainment input type;
determining a task priority for temporally overlapping a schedule task with the entertainment break period;
calculating an adjusted entertainment schedule based on the task priority for engaging in the entertainment activity and the schedule task; and
generating a task-suggestion based on the adjusted entertainment schedule for displaying on a device.

2. The method as claimed in claim 1 further comprising:
determining a task-completion status for completing the schedule task; and
setting an entertainment-continuation status based on the task-completion status for continuing the entertainment activity.

3. The method as claimed in claim 1 further comprising:
determining a task context for overlapping the schedule task; and
wherein:
determining the task priority includes determining the task priority based on the task context.

4. The method as claimed in claim 1 wherein:
detecting the entertainment break period includes calculating a break-period grouping having the entertainment break period; and
further comprising:
determining a task grouping corresponding to the task context for overlapping the break-period grouping, with the task grouping having the schedule task.

5. The method as claimed in claim 1 wherein:
determining the schedule task includes identifying an entertainment-concurrent task having a sequential connection to the schedule task; and
generating the task-suggestion includes generating the task-suggestion for suggesting the entertainment-concurrent task.

6. A method of operation of an entertainment system comprising:
identifying an entertainment input type for classifying an entertainment activity involving a first device;
determining an entertainment priority based on the entertainment input type;
detecting an entertainment break period based on the entertainment input type;
determining a task priority for temporally overlapping a schedule task involving a second device with the entertainment break period;
calculating an adjusted entertainment schedule for engaging in the entertainment activity and the schedule task; and
generating a task-suggestion based on the adjusted entertainment schedule for displaying on the first device.

7. The method as claimed in claim 6 wherein calculating the adjusted entertainment schedule includes calculating the adjusted entertainment schedule based on comparing the schedule task and the task priority to the entertainment break period and the entertainment priority.

8. The method as claimed in claim 6 further comprising identifying an interruption scenario based on the task priority for interrupting the entertainment activity.

9. The method as claimed in claim 6 further comprising:
receiving a device-status for identifying a status of the second device; and
generating a schedule update based on the device-status for displaying on the first device.

10. The method as claimed in claim 6 further comprising:
identifying an substitute availability for engaging in the entertainment activity; and
wherein:
calculating the adjusted entertainment schedule includes calculating the adjusted entertainment schedule based on the substitute availability and the entertainment priority.

11. An entertainment system comprising:
a type-identification module for identifying an entertainment input type for classifying an entertainment activity;
a break detection module, coupled to the type-identification module, for detecting an entertainment break period based on the entertainment input type;
a task detail module, coupled to the break detection module, for determining a task priority for temporally overlapping a schedule task with the entertainment break period;
a schedule optimization module, coupled to the task detail module, for calculating an adjusted entertainment schedule based on the task priority for engaging in the entertainment activity and the schedule task; and
a message generator module, coupled to the schedule optimization module, for generating a task-suggestion based on the adjusted entertainment schedule for displaying on a device.

12. The system as claimed in claim 11 further comprising:
a schedule module, coupled to the task detail module, for determining a task-completion status for completing the schedule task; and
an activity continuation module, coupled to the device-update module, for setting an entertainment-continuation status based on the task-completion status for continuing the entertainment activity.

13. The system as claimed in claim 11 further comprising:
a schedule module, coupled to the task detail module, for determining a task context for overlapping the schedule task having the task context; and
wherein:
the task detail module is for determining the task priority based on the task context.

14. The system as claimed in claim 11 further comprising:
a break grouping module, coupled to the type-identification module, for calculating a break-period grouping having the entertainment break period; and
a task grouping module, coupled to the task detail module, for determining a task grouping corresponding to the task context for overlapping the break-period grouping, with the task grouping having the schedule task.

15. The system as claimed in claim 11 further comprising:
a concurrence determination module, coupled to the schedule optimization module, for determining the schedule task includes identifying an entertainment-concurrent task having a sequential connection to the schedule task; and
wherein:
the message generator module is for generating the task-suggestion for suggesting the entertainment-concurrent task.

16. The system as claimed in claim 11 wherein:
the type-identification module is for identifying the entertainment input type for classifying the entertainment activity involving a first device;
the task detail module is for determining the task priority for temporally overlapping the schedule task involving a second device with the entertainment break period;
the message generator module is for generating the task-suggestion based on the adjusted entertainment schedule for displaying on the first device; and
further comprising:
an entertainment detail module, coupled to the type-identification module, for determining an entertainment priority based on the entertainment input type.

17. The system as claimed in claim 16 wherein the schedule optimization module is for calculating the adjusted entertainment schedule based on comparing the schedule task and the task priority to the entertainment break period and the entertainment priority.

18. The system as claimed in claim 16 wherein the message generator module is for identifying an interruption scenario based on the task priority for interrupting the entertainment activity.

19. The system as claimed in claim 16 further comprising:
a device-update module, coupled to the type-identification module, for receiving a device-status for identifying a status of the second device; and
wherein:
the message generator module is for generating a schedule update based on the device-status for displaying on the first device.

20. The system as claimed in claim 16 further comprising:
an entertainment alternative module, coupled to the type-identification module, for identifying an substitute availability for engaging in the entertainment activity; and
wherein:
the schedule optimization module is for calculating the adjusted entertainment schedule based on the substitute availability and the entertainment priority.
